(19) United States
(12) Patent Application Publication
(10) Pub. No.: US 2022/0149775 A1
(43) Pub. Date: May 12, 2022

(54) SOLAR PANEL ASSEMBLY

(71) Applicant: SAINT-AUGUSTIN CANADA ELECTRIC INC., Saint-Augustin-De-Desmaures (CA)

(72) Inventor: Sébastien ARCAND, Saint-Augustin-De-Desmaures (CA)

(73) Assignee: SAINT-AUGUSTIN CANADA ELECTRIC INC., Saint-Augustin-De-Desmaures (CA)

(21) Appl. No.: 17/585,334

(22) Filed: Jan. 26, 2022

Related U.S. Application Data
(62) Division of application No. 16/618,933, filed on Dec. 3, 2019.
(60) Provisional application No. 62/515,235, filed on Jun. 5, 2017.

(51) Int. Cl. H02S 20/32; H02S 30/10; H02S 40/22; H02S 40/42; G01W 1/10

(52) U.S. Cl. CPC H02S 20/32; H02S 30/10; G01W 1/10; H02S 40/42; H02S 40/22

(57) ABSTRACT

A solar panel assembly comprising: a base plate extending between a first face and a second face; a plurality of concentrated photovoltaic (CPV) cells mounted on the first face of the base plate; a plurality of optical concentrators each facing a respective one of the CPV cells; each one of the optical concentrators and the respective one of the CPV cells forming a CPV module for converting direct light into electricity; and a plurality of photovoltaic (PV) cells for converting indirect light into the electricity.

### CROSS-REFERENCE TO RELATED APPLICATIONS

This application is a divisional of U.S. patent application Ser. No. 16/618.933, filed Dec. 3, 2019, which is a National Phase Application of PCT International Application No. PCT/IB 2018/054019, International Filing Date Jun. 5, 2018, claiming benefit of U.S. Provisional Patent Application No. 62/515,235, filed on Jun. 5, 2017, all of which are hereby incorporated by reference.

### TECHNICAL FIELD OF THE INVENTION

The present invention relates to the field of solar energy generator, and more particularly to solar panel assemblies.

### BACKGROUND OF THE INVENTION

Solar cells are electrical devices that convert the energy of light directly into electricity by the photovoltaic effect. Usual solar cells which are based on silicon have a limited efficiency. They usually convert less than 25% of the energy of the light into electricity.

In order to increase the efficiency of solar cells, concentrated photovoltaic (CPV) cells have been developed. Such solar cells present an improved efficiency of over 30%. While being efficient under sunny conditions, CPV cells are less efficient than usual solar cells under cloudy conditions.

Therefore, there is a need for an improved solar panel assembly.

### SUMMARY OF THE INVENTION

According to a first broad aspect, there is provided a solar panel assembly comprising: a base plate extending between a first face and a second face; a plurality of concentrated photovoltaic (CPV) cells mounted on the first face of the base plate; a plurality of optical concentrators each facing a respective one of the CPV cells; each one of the optical concentrators and the respective one of the CPV cells forming a CPV module for converting direct light into electricity; and a plurality of photovoltaic (PV) cells for converting indirect light into the electricity.

In one embodiment, the PV cells are mounted on the first face of the base plate.

In one embodiment, the solar panel assembly further comprises a secondary plate extending between a front face and a rear face.

In one embodiment, the PV cells being mounted on the front face of the secondary plate.

In one embodiment, he base plate is at least semi-transparent and the secondary plate is positioned beneath the base plate so that the PV cells face the second face of the base plate.

In one embodiment, the secondary plate is at least semi-transparent and the base plate is positioned beneath the secondary plate so that the CPV cells and the optical concentrators face the rear face of the secondary plate.

In one embodiment, the PV cells are mounted on the rear face of the secondary face, the front face of the secondary plate facing the second face of the base plate.

In one embodiment, the base plate is made of heat sink material.

According to a second broad aspect, there is provided a solar panel assembly comprising: a first plate extending between a first face and a second face; a plurality of concentrated photovoltaic (CPV) cells mounted on the first face of the base plate; a plurality of optical concentrators each facing a respective one of the CPV cells; each one of the optical concentrators and the respective one of the CPV cells forming a CPV module for converting direct light into electricity; a secondary plate extending between a front face and a second face, the front face facing the second face of the base plate; and a plurality of primary photovoltaic (PV) cells mounted on the rear face of the secondary plate for converting indirect light into the electricity.

In one embodiment, the solar panel assembly further comprises additional PV cells mounted on the first face of the base plate.

In one embodiment, the solar panel assembly further comprises an additional plate extending between a front surface and a rear surface.

In one embodiment, the PV cells being mounted on the front face of the secondary plate.

In one embodiment, the base plate is at least semi-transparent and the additional plate is positioned beneath the base plate so that the additional PV cells face the second face of the base plate.

In one embodiment, the additional plate is at least semi-transparent and the base plate is positioned beneath the additional plate so that the CPV cells and the optical concentrators face the rear surface of the secondary additional plate.

According to another broad aspect, there is provided a solar panel system comprising: a motorized rotatable frame; the solar panel assembly of claim 9, the solar panel assembly being secured to the rotatable frame; a controller for determining which ones of the CPV cells and the PV cells should be exposed and rotating the motorized rotatable frame in order to expose the determined cells.

In one embodiment, the controller is adapted to perform the determination as a function of information about weather forecast.

In one embodiment, the information about weather forecast comprises a cloud coverage percentage and an altitude of clouds.

In the present description, a solar cell or a photovoltaic (PV) cell refers to any an electrical device adapted to convert the energy of light into electricity by the photovoltaic effect.

In the present description, the expression “PV solar cell” refers to a standalone solar cell which is used alone for converting light into electricity, i.e., a PV solar cell is not coupled or combined to any optical device such as a concentrator or a lens for converting light into electricity.

A PV solar cell may be any solar cell such as a thin-film solar cell, a conventional single junction solar cell made of multicrystalline and monocrystalline silicon. A PV solar cell may also be a multi-junction solar cell comprising a substrate such as a gallium arsenide substrate, a germanium substrate, an indium phosphide substrate, an indium gallium nitride substrate, or the like. A PV solar cell may also be a solar cell comprising cadmium telluride solar cell, a copper indium gallium selenide (CIGS) solar cell, an amorphous silicon solar cell, etc.

The expression “concentrated photovoltaic (CPV) solar cell” or “CPV solar cell” refers to a solar cell that is used in combination with an optical concentrator such as an optical lens for converting light into electrical energy. The assembly of a CPV solar cell and its corresponding concentrator is referred to as a CPV module or CPV solar module. The optical concentrator is positioned between the CPV solar cell and the source of light, e.g. the sun, for concentrating or focusing at least some of the light incident thereon on the CPV solar cell.

A CPV solar cell may be any solar cell such as a thin-film solar cell, a conventional single junction solar cell made of multicrystalline and monocrystalline silicon. A CPV solar cell may also be a multi-junction solar cell comprising a substrate such as a gallium arsenide substrate, a germanium substrate, an indium phosphide substrate, an indium gallium nitride substrate, or the like. A CPV solar cell may also be a solar cell comprising cadmium telluride solar cell, a copper indium gallium selenide (CIGS) solar cell, an amorphous silicon solar cell, etc.

In one embodiment, a PV solar cell is chosen so as to be a low efficiency solar cell. In this case, a PV solar cell may be a thin film solar cell, a single junction solar cell, or the like. Such as PV solar cell may be sometimes referred to as a low efficiency solar cell. In the case of a single junction solar cell, the efficiency in converting light energy into electricity is usually below 25% with a maximum theoretical efficiency of 33.16%.

In the same embodiment, a CPV solar cell is chosen to be a high efficiency solar cell, e.g., a solar cell having an efficiency of at least 30%. In another embodiment, a CPV solar cell is chosen to be solar cell provided with at least two junctions. In this case, a CPV solar cell may be a gallium arsenide substrate, a germanium substrate, an indium phosphide substrate, an indium gallium nitride substrate, or the like.

### BRIEF DESCRIPTION OF THE DRAWINGS

Further features and advantages of the present invention will become apparent from the following detailed description, taken in combination with the appended drawings, in which:

FIG. 1 illustrates a solar panel system comprising solar panels positioned according to a first orientation and having solar cells on a single face of the solar panels, in accordance with an embodiment;

FIG. 2 illustrates the solar panel system of FIG. 1 of which the solar panels are positioned according to a second orientation;

FIG. 3 illustrates a solar panel of the solar panel system of FIG. 1;

FIG. 4 illustrates a solar cell assembly contained in the solar panel of FIG. 3, the solar cell assembly comprising a concentrator plate and CPV and PV solar cells mounted on a same support plate, in accordance with an embodiment;

FIG. 5 illustrates the support plate of FIG. 4 provided with the CPV and PV solar cells;

FIG. 6 illustrates a solar cell assembly comprising a concentrator plate, a first support plate on which CPV solar cells are mounted and a second support plate on which PV solar cells are mounted, the CPV and PV solar facing the concentrator plate, in accordance with an embodiment;

FIG. 7 illustrates a solar panel system comprising solar panels positioned according to a first orientation and having solar cells on both faces of the solar panels, in accordance with an embodiment;

FIG. 8 illustrates the solar panel system of FIG. 7 of which the solar panels are positioned according to a second orientation;

FIG. 9 illustrates a solar cell assembly comprising a concentrator plate, a first support plate on which CPV solar cells and first PV solar cells are mounted and a second support plate on which second PV solar cells are mounted, the second PV solar having an orientation opposite to that of the CPV and first PV solar cells, in accordance with an embodiment;

FIG. 10 is a block diagram illustrating a controller for controlling the orientation of solar panels, in accordance with an embodiment; and

FIG. 11 illustrates a solar cell assembly comprising a concentrator plate, a first support plate on which CPV solar cells and heat sinks are mounted, a second support plate on which first PV solar cells are mounted and a third support plate on which second solar cells, the CPV and first solar cells facing the concentrator plate and the second PV solar having an orientation opposite to that of the CPV and first PV solar cells, in accordance with an embodiment.

It will be noted that throughout the appended drawings, like features are identified by like reference numerals.

### DETAILED DESCRIPTION OF THE INVENTION

Usually, a solar panel comprises an array of solar cells which are all of the same type or identical. For example, a usual solar panel may comprise an array of PV solar cells. Such a solar panel presents the advantage of being operable under different weather conditions since it may convert direct, indirect, diffused and/or refracted light into electricity with an acceptable efficiency. However, the maximal efficiency of a solar panel comprising PV solar cells is limited even under sunny weather conditions. Alternatively, a usual solar panel may comprise an array of CPV solar cells. Under sunny weather conditions, such a CPV cell panel provides an efficiency that is greater than that of a PV cell panel for direct light only. However, under certain conditions such as cloudy weather conditions, a CPV cell panel offers an efficiency that is less than that of a PV cell panel.

There is described herein a solar panel system which combines both conventional PV solar cells and CPV solar cells so as to take advantage of both technologies. As described below, the solar panel system comprises a solar panel assembly which contains both PV and CPV solar cells and a tracking system for orienting the solar panel assembly.

In one embodiment, the PV solar cells and the CPV solar cells are located on a same side of the solar panel assembly. For example, the PV and CPV solar cells may be secured to a same plate. Alternatively, the CPV solar cells may be mounted on a transparent or semi-transparent front plate and the PV solar cells may be mounted on a second and rear plate positioned beneath the front plate so that to collect part of the light that propagates through the front plate.

In another embodiment, the PV solar cells and the CPV solar cells are located on opposite sides of the solar panel assembly, i.e., the PV side and the CPV side. In this case, the tracking system is adapted to determine which side of the solar panel assembly should be exposed, i.e., which side of the solar panel assembly should face the sky.

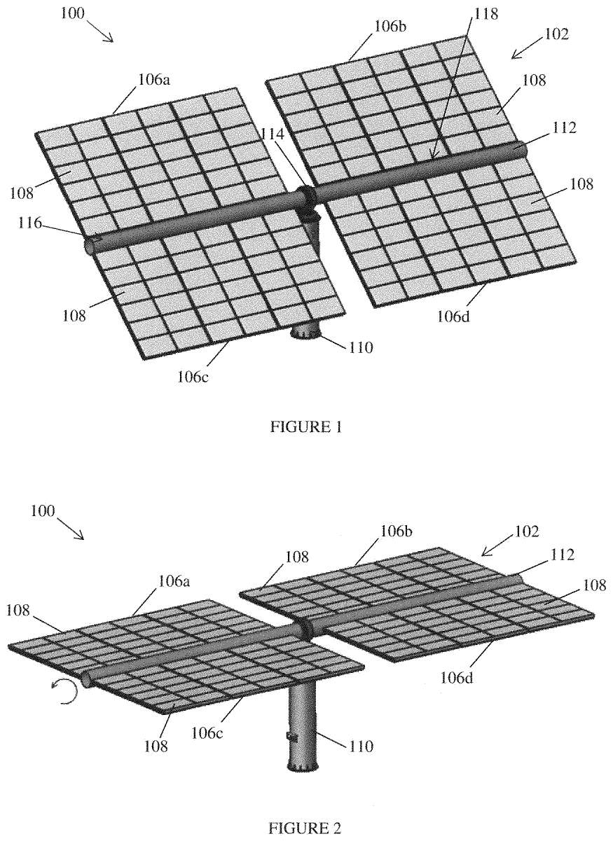

FIGS. 1 and 2 illustrate one embodiment of a solar panel system 100 which combines both CPV solar cells and PV solar cells on a same side of the solar panel system 100. The solar panel system 100 comprises a solar panel assembly 102 and a tracking system. The solar panel assembly 102 comprises four solar panels 106a, 106b, 106c and 106d each comprising an array of solar modules 108. Each solar module 108 comprises both CPV solar cells and PV solar cells as described below.

The tracking system comprises a frame to which the solar panel assembly 102 is mounted and a controller (not shown). In the illustrated embodiment, the frame comprises a first vertical post 110 extending along a first axis and a second horizontal post 112 extending along a second axis and rotatably secured to the first post 110. In the illustrated embodiment, the first axis is extends along a first direction, i.e. a vertical direction, and the second axis is orthogonal to the first axis, i.e., horizontal. However, it should be understood that other configurations may be possible.

The frame is motorized so that the orientation of the solar panels 106a, 106b, 106c and 106d may be varied in order to track the sun. It should be understood that any adequate motorized frame adapted to change the orientation of the solar panels 106a, 106b, 106c and 106d may be used.

For example, the frame may comprise a first motor for rotating the solar panels 106a, 106b, 106c and 106d about the longitudinal axis of the post 110 and a second motor for rotating the solar panels 106a, 106b, 106c and 106d about the longitudinal axis of the post 112.

Referring back to FIGS. 1 and 2 and in one embodiment, the second post 112 may rotate about the second axis, i.e., about its own longitudinal axis, so as to vary the orientation of the solar panels 106. In this case, the first post 110 may have a fixed position and the second post 112 may be rotatably secured to the first post 110 via a rotatable connection such as a revolute joint in order to rotate the second post 112 relative to the first post 110 and about the second axis.

In another embodiment, the second post 112 may rotate about the first axis, i.e., about the longitudinal axis of the first post 110. In this case, the first post 110 may have a fixed position and the second post 112 may be rotatably secured to the first post 110 via a rotatable connection such as a revolute joint in order to rotate the second post 112 relative to the first post 110 and about the first axis. In another example, the second post 112 may have a fixed position relative to the first post 110 and the first post 110 may be rotatable about its longitudinal axis, i.e. about the first axis.

In a further embodiment, the second post 112 may rotate about both the first and second axes.

In the illustrated embodiment, a rotating connector 114 rotatably connects the second post 112 to the first post 110 so that the second post 112 be rotatable about the second axis. The rotating connector 114 is secured at the top of the first post 110 and substantially at the middle of the second post 112, thereby splitting the second post 112 into a first post section 116 extending on a first side of the rotating connector 114 and a second post section 118 extending on a second and opposite side of the rotating connector 114. The solar panel 106a is secured to the first post section 116 and extends therefrom on a first side thereof while the solar panel 106d is also secured to the first post section 116 but extends from a second and opposite side thereof. The solar panel 106b is secured to the second post section 118 and extends therefrom on a first side thereof while the solar panel 106c is also secured to the second post section 118 but extends from a second and opposite side thereof. In the illustrated embodiment, the solar panels 106a, 106b, 106c, and 106d are substantially coplanar.

It should be understood that any adequate frame adapted to support the solar panels 106a, 106b, 106c, and 106d and having at least one degree of freedom to vary the orientation of the solar panels 106a, 106b, 106c, and 106d may be used. It should also be understood that the number of solar panels 106a, 106b, 106c, and 106d and/or the number of solar modules 108 per solar panel 106a, 106b, 106c, 106d may also vary. For example, the solar panel assembly 102 may comprise a single solar panel 106a, 106b, 106c, 106d comprising a single solar module 108.

The tracking system further comprises a controller (not shown) for controlling the orientation of the solar panels 106a, 106b, 106c, and 106d in order to track the sun, as known in the art. In one embodiment, the controller adjust the orientation of the solar panels 106a, 106b, 106c, and 106d so that the line of sight to the sun to substantially normal to the surface of the solar panels 106a, 106b, 106c, and 106d.

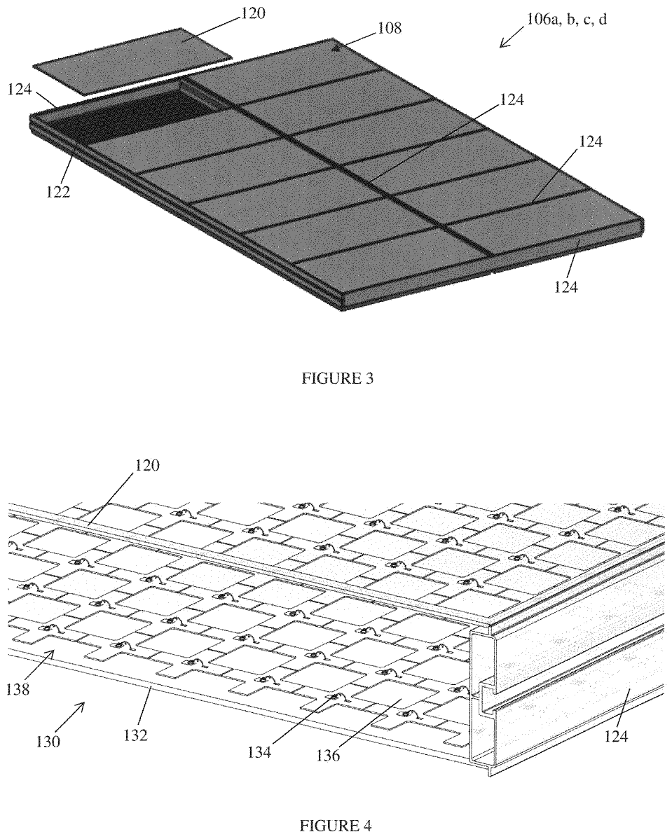

As illustrated in FIG. 3, each solar panel 106a, 106b, 106c, 106d comprises a plurality of solar modules 108 and each solar module 108 comprises a concentrator plate 120 and a solar cell assembly 122 comprising a plurality of solar cells. The solar panel 106a, 106b, 106c, 106d further comprises a frame for securing the solar modules 108 together. In the illustrated embodiment, the frame comprises a plurality of plates 124 secured together to form the frame. The different solar cell assemblies 122 and their respective concentrator plate 120 are secured to four plates 124 to form the solar panel 106a, 106b, 106c, 106d.

In one embodiment, the solar panel 106a, 106b, 106c, 106d comprises a base plate on which the solar cell assembly 122 are secured and from which the plates 124 projects. As a result a first end of the plates 124 is secured to the base plate and the solar cell assemblies are secured to the base plate between plates 124. The concentrator plates 120 are secured to the plates 124 adjacent to the second end thereof. The solar cells are installed on the solar cell assembly 122 so as to face their respective concentrator plate 120.

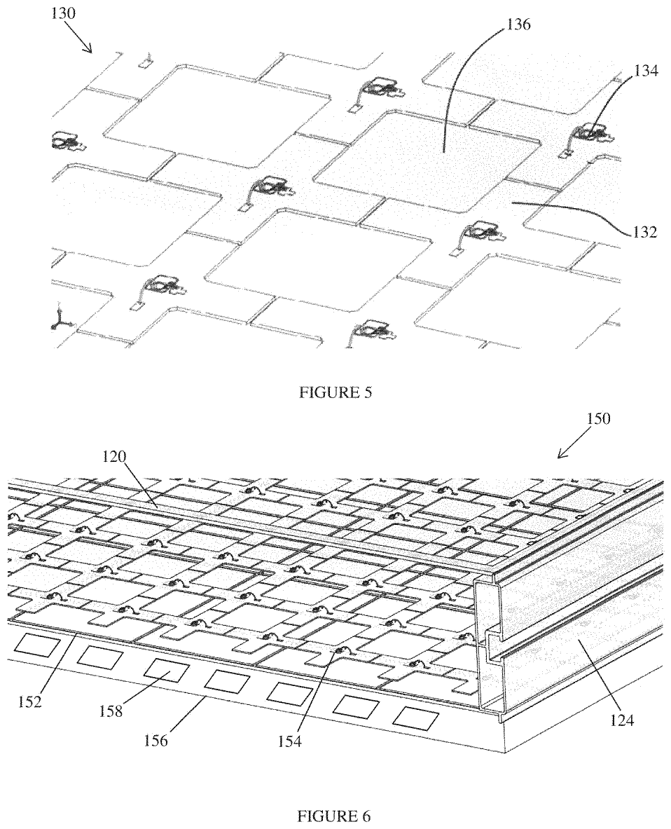

FIGS. 4 and 5 illustrate one embodiment of a solar cell assembly 130 which may be used as solar cell assembly 122. The solar cell assembly 130 comprises a support plate 132, a plurality of CPV solar cells 134 and a plurality of PV solar cells 136. The CPV and PV solar cells 134 and 136 are mounted on a same face 138 of the support plate 132 to form an array of CPV solar cells 134 and an array of PV solar cells 136. As illustrated in FIG. 5, the arrays of CPV and PV solar cells 134 and 136 are positioned on the support plate 132 so that one row of CPV solar cells 134 alternates with one row of PV solar cells 136 along the length of the support plate 132. Furthermore, the CPV solar cells 134 and the PV solar cells 136 are arranged in a stepwise manner, i.e., the rows of PV solar cells 136 are shifted relative to the rows of PV solar cells 136 so that each CPV solar cell 134 is adjacent to four PV solar cells 136 and is located at the center of the square or rectangle formed by the centers of the four adjacent or neighbor PV solar cells 136.

It should be understood that the particular geometrical arrangement of the CPV and PV solar cells 134 and 136 is exemplary only. For example, the CPV and PV solar cells 134 and 136 may be randomly distributed on the face 138 of the support plate 132. Similarly, while a solar cell assembly 130 may comprise an even number of CPV and PV solar cells 134 and 136, it should be understood that the number of CPV solar cells 134 may be different from that of PV solar cells 136.

Referring back to FIG. 4, the width of the plate 124 may be chosen so that the concentrator plate 120 be at a predefined distance from the CPV solar cells 134. The concentrator plate 120 comprises a plurality of concentrators (not shown) each positioned for concentrating or focusing the light incident thereon onto a respective CPV solar cell 134. For example, each concentrator may be positioned on the concentrator plate 120 so as to be aligned with its respective CPV solar cell 134, i.e., the axis between the center of a concentrator and the center of its respective CPV solar cell 134 may be orthogonal to the concentrator plate 120 and the support plate 132. As a result, the concentrator plate 120 comprises an array of concentrators which is aligned with the array of CPV solar cells 134. The assembly formed by a CPV solar cell 134 and its respective concentrator corresponds to a CPV solar module.

The concentrator plate 120, including the concentrators integrated therein, is made of transparent or semi-transparent material such as glass, plastic, or the like. The light that is incident on a given concentrator is at least partially focused on its respective CPV solar cell 134 which converts the received light into electricity. The light that is incident on the concentrator plate 120 between concentrators propagates through the concentrator plate 120 while not being focused by the concentrator plate 120. Some of the non-concentrated light reaches the PV solar cells 136 which in turn convert the light incident thereon into electricity.

As a result of the particular arrangement of CPV and PV solar cells 134 and 136, the solar panel 106a, 106b, 106c, 106d is adapted to convert both direct light and indirect light into electricity. The direct light refers to light that is incident on the concentrator plate 120 with an incident angle of about 90°. It should be understood that some tolerance may exist on the value of the incident angle of light to be considered as direct light. For example, all light having a given incident angle so that when being incident on a given concentrator at the given incident angle is being focused on the CPV solar cell corresponding to the given concentrator may be considered as direct light. The indirect light refers to light that is incident on the concentrator plate 120 with an incident angle other than about 90°. Similarly to the direct light, it should be understood that some tolerance may exist on the range of values for the incident angle of indirect light. In one embodiment, all light incident on the concentrator plate 120 with a given incident angle so that when incident on a concentrator the light is not focused on a CPV solar cell may be considered as indirect light. The indirect light may comprise diffuse light, light reflected by objects surrounding the solar panel, etc.

It should be understood that the tracking system 104 may use any adequate method for tracking the sun. In one embodiment, the controller may be adapted to receive the theoretical position of the sun and orient the solar panel assembly 102 as a function of the theoretical position of the sun.

In another embodiment, the tracking system 104 may further comprise at least one sun tracking sensor adapted to determine the actual position of the sun. In this case, the controller is adapted to orient the solar panel assembly 102 using the determined position of the sun, as known in the art. In an embodiment in which the tracking system 104 comprises a sun tracking sensor, the controller may be adapted to orient the solar panel assembly 102 using the theoretical position of the sun when the sun tracking sensor is unable to determine the actual position of the sun, e.g., under cloudy conditions.

In one embodiment, the tracking system 104 comprises a first sun tracking sensor adapted to provide a first evaluation of the actual position of the sun and a second sun tracking sensor adapted to provide a refined evaluation of the actual position of the sun. For example, the first sun tracking sensor may be a global normal irradiance (GNI) sensor or a direct normal irradiance (DNI) sensor. The second sun tracking sensor may be a 4-quadrant (4Q) sensor. In this case, the controller receives the actual position of the sun from the first sun tracking sensor and adjusts the position of the solar panel assembly 102 accordingly. Then, the controller receives the actual position of the sun measured by the second sun tracking sensor and, if necessary, adjusts the position of the solar panel assembly 102 according to the new position of the sun received from the second sun tacking sensor.

In one embodiment and once the solar panel assembly 102 has been positioned according to the position of the sun measured by the second sun tracking sensor, the controller may measure the power generated by the solar panel assembly 102 and performs a fine tuning step. In this optional step, the controller slightly varies the orientation of the solar panel assembly 102 around a reference orientation which corresponds to the orientation of the solar assembly 102 determined using the position of the sun measured by the second sun tracking sensor while measuring the energy generated by the solar panel assembly 102. If a given orientation provides a generated energy being greater than the energy generated for the reference orientation, the controller then orients the solar panel assembly 102 according to the given orientation.

In another embodiment, the controller may perform the fine-tuning step only when the measured energy generated for the orientation of the solar panel assembly 102 corresponding the position of the sun determined by the second sun tracking sensor is below a given threshold.

It should be understood that the distance between a CPV solar cell 134 and a respective concentrator, i.e., the distance between the support plate 132 and the concentrator plate 120, is chosen as a function of the characteristics of the CPV solar cells 134 such as their dimension and the characteristics of the concentrators. In one embodiment, the distance between the support plate 132 and the concentrator plate 120 is chosen so as to maximize the amount of light incident of the CPV light cells 134.

In one embodiment, the external face of the concentrator plate 120, i.e., the face of the concentrator plate 120 which is opposite to the solar cell assembly 122, 130, is coated with an anti-reflective coating in order to minimize the reflection of light.

It should be understood that any adequate concentrator for focusing light on a CPV solar cell 134 may be used. For example, the concentrators may be convex or biconvex optical lenses. In another example, the concentrators may be Fresnel lenses.

In one embodiment, the solar cell assembly 130 further comprises a plurality of heat sinks for dissipating the heat generated by the CPV solar cells 134 and/or the PV solar cells 136. For example, each CPV solar cell 134 and/or each PV solar cell may be mounted on a respective heat sink which is secured to or integrated on the support plate 132. In another embodiment, the support plate 132 may be made of a heat sink material and then acts as a heat sink for dissipating the heat generated by the CPV and PV solar cells 134 and 136. For example, the support plate 132 may be made of aluminum alloy, copper, composite material such as copper-tungsten pseudoalloy, AlSiC (silicon carbide in aluminum matrix), Dymalloy (diamond in copper-silver alloy matrix), E-Material (beryllium oxide in beryllium matrix), etc.

While in the solar cell assembly 130, the CPV and PV solar cells 143 and 136 are integrated on a same support plate 132, FIG. 6 illustrates a solar cell assembly 150 which comprises a first support plate 152 for supporting CPV solar cells 154 and a second support plate 156 for supporting PV solar cells 158. The second support plate 156 is located beneath the first support plate 152, i.e., the first support plate 152 is positioned between the concentrator plate 120 and the second support plate 156. The first support plate 152 is at least partially made of transparent or semi-transparent material so as to allow at least some of the light incident thereon propagating therethrough. As for the solar assembly 130, the plate 124 is used for positioning the first support plate 152 at a given distance from the concentrator plate 120. In this embodiment, the concentrator plate 120, the first support plate 152 and the second support plate 156 are all parallel to one another. However, the person skilled in the art will understand that other configurations may be possible. For example, the second support plate 156 may not be parallel to the first support plate 152 which may be parallel to the concentrator plate 120.

In the illustrated embodiment, the CPV solar cells 154 are geometrically arranged on the first support plate 152 so as to form an array of CPV solar cells 154. Similarly, the PV solar cells 158 are geometrically arranged on the first support plate 156 so as to form an array of CPV solar cells 158. In one embodiment, the position of the PV solar cells 158 on the second support plate 156 is chosen as a function of that of the CPV solar cells 154 on the first support plate 152 so that the rows of PV solar cells 158 are shifted relative to the rows of CPV solar cells 154. As result, the projection of each PV solar cell 158 on the first support plate 152 is located between four adjacent CPV solar cells 154. In one embodiment, the projection of each PV solar cell 158 on the first support plate 152 is located substantially at the center of the geometric shape formed by the centers of the four adjacent CPV solar cells 154.

It should be understood that the relative position between the CPV solar cells 154 and their respective concentrators is chosen so that the direct light being incident on the concentrators is focused on their respective CPV solar cells 154 which convert the light incident thereon into electricity. It should be understood that some of the indirect light that is incident on the concentrator plate 120 between concentrators may reach a CPV solar cell 154 and be converted into electricity. The indirect light being incident on the concentrator plate 120 and the direct light incident on the concentrator plate 120 between concentrators propagate through the concentrator plate 120 before reaching the first support plate 152. Since the first support plate 152 is transparent or semi-transparent, at least some of the light incident on the first support plate 152 between CPV solar cells 154 propagates through the first support plate 152 and reaches a PV solar cells 158 located on the second support plate 156. The PV solar cells 158 then convert the received light into electricity.

In one embodiment, the solar cell assembly 150 further comprises a plurality of heat sinks for dissipating the heat generated by the CPV solar cells 154 and/or the PV solar cells 158. For example, each CPV solar cell 154 and/or each PV solar cell 158 may be mounted on a respective heat sink which is secured to or integrated on their respective support plate 152, 156. In another embodiment, the support plate 156 may be made of a heat sink material and then acts as a heat sink for dissipating the heat generated by the PV solar cells 158 mounted thereto. In one embodiment, the support plate 152 may be made of a transparent or semi-transparent heat sink material.

While in the solar cell assembly 150 illustrated in FIG. 5 the first support plate 152 is positioned between the second support plate 156 and the concentrator plate 120, it should be understood that the second support plate 156 may be positioned between the first support plate 152 and the concentrator plate 120. In this case, the second support plate 156 is made of a transparent or semi-transparent material and the first support plate 152 may not be made of a transparent or semi-transparent material. In this embodiment, the direct light incident on the concentrators of the concentrator plate 120 propagates through the second support plate 156 before reaching the CPV solar cells 154. In one embodiment, the second support plate may be provided with secondary concentrators so that each concentrator of the concentrator plate 120 focused the direct light incident thereon onto a respective secondary concentrator present on the second support plate and each secondary concentrator focused the light incident thereon on a respective CPV solar cell 154.

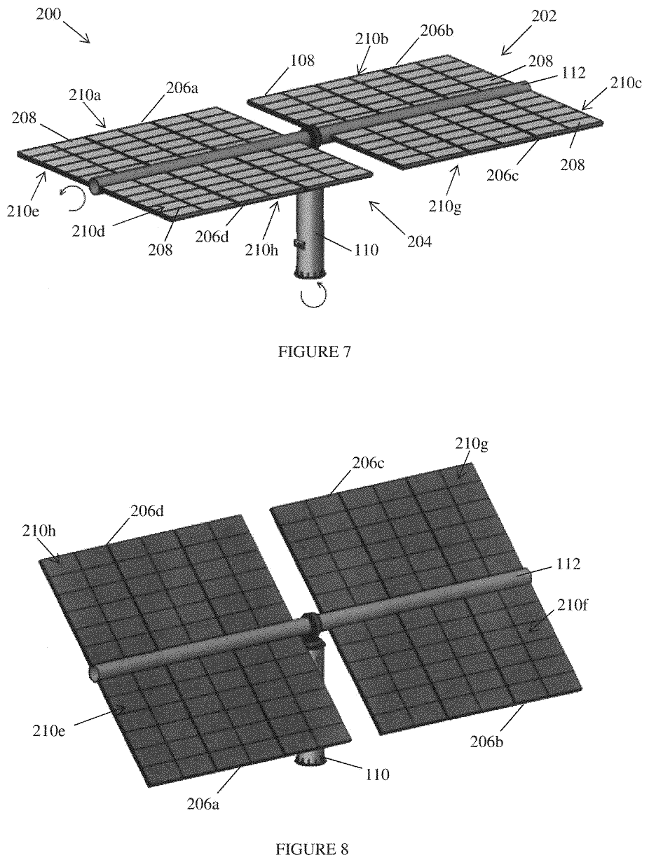

While the solar panel system 100 comprises both CPV and PV solar cells 134, 154 and 136, 158 integrated on the same side of a solar panel assembly 102, FIGS. 7-9 illustrates a solar panel system 200 which comprises CPV solar cells and PV solar cells integrated on opposite sides of a solar panel assembly.

The solar panel system 200 comprises a solar panel assembly 202 and a tracking system 204. The solar panel assembly 202 comprises four solar panels 206a, 206b, 206c and 206d each comprising an array of solar modules 208. Each solar module 208 comprises both CPV solar cells and PV solar cells positioned on opposite sides of the solar module 208, as described below.

The tracking system 204 comprises a frame to which the solar panel assembly 202 is mounted and a controller (not shown). In the illustrated embodiment, the frame corresponds to the frame of the tracking system 104 of the solar panel system 100, i.e., it comprises the first vertical post 110 and the second horizontal post 112. In the illustrated embodiment, the solar panel assembly 202 may rotate about the axis of the first post 110 and about the axis of the second post 112. However and as described above, other configurations are possible as long as the solar panel assembly 202 may rotate about the longitudinal axis of the second post 112.

Each solar panel 206a, 206b, 206c, 206d comprises a first face 210a, 210b, 210c, 210d, respectively, and a second an opposite face 210e, 210f, 210g, 210h, respectively. While FIG. 7 illustrates a configuration in which the first face 210a, 210b, 210c, 210d of the solar panels 206a, 206b, 206c and 206d is exposed, i.e. the first face 210a, 210b, 210c, 210d faces the sky while the second face 210e, 210f, 210g, 210h faces the ground, the second face 210e, 210f, 210g, 210h of the solar panels 206a, 206b, 206c and 206d may be exposed by rotating the second post 112 about its longitudinal axis.

Each solar module 208 is also provided with a first face 208a and a second and opposite face 208b. The first face 208a is on the same side of the solar panel assembly 202 as the first face 210a, 210b, 210c, 210d of the solar panels 206a, 206b, 206c and 206d and the second face 208b is on the same side of the solar panel assembly 202 as the second face 210e, 210f, 210g, 210h of the solar panels 206a, 206b, 206c and 206d. The first and second face 208a and 208b of the solar modules 208 can be selectively exposed by rotating the second post 112 about its longitudinal axis.

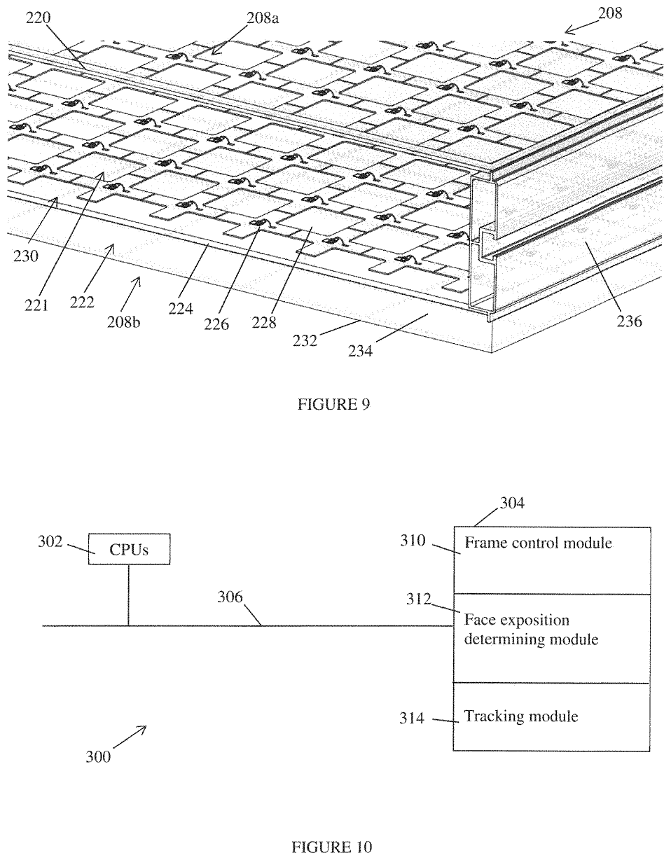

As illustrated in FIG. 9, a solar module 208 comprises a first solar cell assembly 221 and a second solar cell assembly 222 which are oriented in opposite directions so that the first solar cell assembly 221 be located on the first side 208a of the solar module 208 and the second solar cell assembly be located on the second side 208b. The solar module 208 further comprises a concentrator plate 220 located on the first side 208a of the solar module 208 and a protection plate (not shown) on the second side 208b of the solar module 208. The concentrator plate 220 is made of a transparent or semi-transparent material and comprises concentrators integrated therein, as described below. The protection plate is also made of a transparent or semi-transparent material and used for protecting solar cells located on the second side 208b of the solar module 208.

The first solar cell assembly 221 comprises a support plate 224, a plurality of CPV solar cells 226 and a plurality of PV solar cells 228. In the illustrated embodiment, the CPV and PV solar cells 226 and 228 are mounted on a same face 230 of the support plate 224 to form an array of CPV solar cells 226 and an array of PV solar cells 228. As illustrated, the arrays of CPV and PV solar cells 226 and 228 are positioned on the support plate 224 so that one row of CPV solar cells 226 alternates with one row of PV solar cells 228 along the length of the support plate 224. Furthermore, the CPV solar cells 226 and the PV solar cells 228 are arranged in a stepwise manner, i.e., the rows of CPV solar cells 226 are shifted relative to the rows of PV solar cells 228 so that each CPV solar cell 226 is adjacent to four PV solar cells 228 and is located at the center of the geometrical shape formed by the centers of the four adjacent PV solar cells 228.

The concentrator plate 220 comprises a plurality of concentrators (not shown) each positioned for concentrating or focusing the light incident thereon onto a respective CPV solar cell 226. For example, each concentrator may be aligned with its respective CPV solar cell 226, i.e., the axis between the center of a concentrator and the center of its respective CPV solar cell 226 may be orthogonal to the concentrator plate 220 and the support plate 224. As a result, the concentrator plate 220 comprises an array of concentrators which is aligned with the array of CPV solar cells 226. Each CPV solar cell 226 and its corresponding concentrator form a CPV solar module.

The second solar cell assembly 222 comprises a support plate 232 and PV solar cells 234 mounted thereto. The support plate 232 is secured to the support plate 224 using a connection plate 236 for example, The support plates 224 and 232 are secured together so that the face of the support plate 224 which comprises no solar cells faces the face of the support plate 232 which comprises no solar cells, i.e., so that the CPV solar cells 226 and the PV solar cells 234 are oriented in opposite directions.

As a result of the particular arrangement of CPV and PV solar cells 226, 228 and 234, the solar panel 206a, 206b, 206c, 206d is adapted to convert light into electricity when its face 210a, 210b, 210c, 210d is exposed, i.e., when facing the sky, (as illustrated in FIG. 7) or when its face 210e, 210f, 210g, 210h is exposed (as illustrated in FIG. 8).

When the faces 210a, 210b, 210c and 210d of the solar panels 206a, 206b, 206c and 206d are exposed, the CPV solar cells 226 convert direct light incident thereon into electricity and the PV solar cells 228 convert both direct and indirect light incident thereon into electricity. When the faces 210e, 210f, 210g and 210h are exposed of the solar panels 206a, 206b, 206c and 206d are exposed, the PV solar cells 234 convert light incident thereon into electricity.

It should be understood that the frame of the solar panel system 200 is motorized so as to control at least the rotation of the second post 112 in order to selectively expose either the faces 210a, 210b, 210c and 210d and the faces 210e, 210f, 210g and 210h of the solar panels 206a, 206b, 206c and 206d and control the orientation of the solar panels 206a, 206b, 206c and 206d. It should also be understood that the controller of the tracking system controls the motorized system, and therefore the rotation of the second post 112.

The controller is further adapted to determine which face of the solar panels 206a, 206b, 206c and 206d should be exposed, i.e., which face should be oriented towards the sky while the other face faces the structure to which the first post 110 is secured such as the ground.

In one embodiment, the controller is adapted to measure the power generated by each face of the solar panels at different points in time and expose the face that generates the greatest measured electrical power. For example, at a first point in time the faces 210a, 210b, 210c and 210d of the solar panels 206a, 206b, 206c and 206d may be exposed and generate a first electrical power. The controller then rotates the solar panels 206a, 206b, 206c and 206d by rotating the post 112 in order to expose the faces 210e, 210f, 210g and 210h of the solar panels 206a, 206b, 206c and 206d and determines the electrical power generated by the faces 210e, 210f, 210g and 210h of the solar panels 206a, 206b, 206c and 206d, i.e., the second electrical power. If the second electrical power is less than the first electrical power, the controller determines that the faces 210a, 210b, 210c and 210d of the solar panels 206a, 206b, 206c and 206d should be exposed and rotates the post 112 so as to expose the faces 210a, 210b, 210c and 210d of the solar panels 206a, 206b, 206c and 206d. If the second electrical power is greater than the first electrical power, the controller then determines that the faces 210e, 210f, 210g and 210h of the solar panels 206a, 206b, 206c and 206d should be exposed and maintains the position of the solar panel assembly 202. At the second point in time, the controller determines again which face of the solar panel assembly 202 provides the greatest electrical power by measuring the electrical power generated by the face being actually exposed and then rotating the solar panel assembly 202 and measuring the electrical power generated by the second face of the solar panel assembly 202. The controller then exposes the face providing the greatest electrical power. The method is then repeated for each point in time.

In one embodiment, the determination of the face of the solar panel assembly providing the greatest electrical power is done periodically.

In one embodiment, first and/or second electrical power corresponds to the maximal electrical power generated by the respective face of the solar panel assembly 202. In order to determine the maximal generated electrical power of a given face of the solar panel assembly 202, the controller is adapted to vary the orientation of the electrical panel assembly 202.

In another embodiment, the controller is adapted to measure the power generated by the face of the solar panel assembly 202 being actually exposed and determine which face of the solar panels 206a, 206b, 206c and 206d should be exposed by comparing the measured electrical power to a predefined threshold. It should be understood that any adequate method and device for measuring the electrical energy generated by the solar panels 206a, 206b, 206c and 206d may be used. For example, a combination of current transformers and voltage transformers may be used as known in the art. For example, when the faces 210a, 210b, 210c and 210d of the solar panels 206a, 206b, 206c and 206d, the controller receives the measurement of the electrical power generated by the CPV solar cells 226 and PV solar cells 228 and compares the generated power value to a first threshold value. If the measured value of the generated electrical power is equal to or above the first threshold, the controller determines that the sides 210a, 210b, 210c and 210d of the solar panels 206a, 206b, 206c and 206d should continue being exposed. On the other end, if the measured value for the generated electrical power is below the first threshold, the controller determines that the faces 210e, 210f, 210g and 210h of the solar panels 206a, 206b, 206c and 206d should be exposed. The controller then rotates the second post 112 in order to expose the faces 210e, 210f, 210g and 210h of the solar panels 206a, 206b, 206c and 206d.

In an embodiment in which the measured electrical power is below the first threshold, the controller is adapted to vary the orientation of the faces 210a, 210b, 210c and 210d of the solar panels 206a, 206b, 206c and 206d while measuring the generated electrical power before exposing the faces 210e, 210f, 210g and 210h of the solar panels 206a, 206b, 206c and 206d. If a new given orientation provides a measured electrical power that is equal to or greater than the first threshold, then the controller determines that the faces 210a, 210b, 210c and 210d of the solar panels 206a, 206b, 206c and 206d should continue being exposed and maintains the given orientation for the solar panels 206a, 206b, 206c and 206d. Otherwise, the controller exposes the faces 210e, 210f, 210g and 210h of the solar panels 206a, 206b, 206c and 206d. Alternatively, the controller may vary the orientation of the faces 210a, 210b, 210c and 210d in order to determine the given orientation providing the maximal electrical power and then compares the maximal electrical power to the first threshold. If the maximal electrical power is equal to or greater than the first threshold, then the controller determines that the faces 210a, 210b, 210c and 210d of the solar panels 206a, 206b, 206c and 206d should continue being exposed and maintains the given orientation for the solar panels 206a, 206b, 206c and 206d. Otherwise, the controller exposes the faces 210e, 210f, 210g and 210h of the solar panels 206a, 206b, 206c and 206d.

When the faces 210e, 210f, 210g and 210h of the solar panels 206a, 206b, 206c and 206d are exposed, the controller compares the measured electrical power generated by the PV solar cells 234 to a second threshold. If the measured electrical power is equal to or below the second threshold, the controller determines that the faces 210e, 210f, 210g and 210h of the solar panels 206a, 206b, 206c and 206d should continue being exposed. However, when the measured electrical power is greater than the second threshold, the controller rotates the second post 112 in order to expose the faces 210a, 210b, 210c and 210d of the solar panels 206a, 206b, 206c and 206d, and then rotates the solar panel assembly 202 in order to expose the faces 210a, 210b, 210c and 210d of the solar panels 206a, 206b, 206c and 206d.

In a further embodiment, the controller is adapted to measure the power generated by the faces 210a, 210b, 210c and 210d of the solar panels 206a, 206b, 206c and 206d and estimates the energy that would be generated by the faces 210e, 210f, 210g and 210h. The controller then exposes the faces which provide the greatest energy. In this embodiment, a calibration step is performed in order to determine the relationship between the energy generated by a PV cell 234 and that generated by a PV solar cell 228 under the same weather conditions. Therefore, by knowing this relationship and the number of PV cells 228 and 234, it is possible to determine the power that would be generated by the faces 210e, 210f, 210g and 210h of the solar panels 206a, 206b, 206c and 206d from the measured power generated by the PV cells 228 present on the faces 210a, 210b, 210c and 210d. In one embodiment, the relationship may be determined empirically by measuring the energy generated by a PV solar cell 228 and the energy generated by a PV solar cell 234 when the PV solar cells 228 and 234 are exposed to the same lighting conditions. In another embodiment, the relationship is determined theoretically using the characteristics of the PV solar cells 228 and those of the PV solar cells 234.

In this embodiment, the controller exposes the faces 210a, 210b, 210c and 210d of the solar panels 206a, 206b, 206c and 206d at different points in time and measures the energy generated by the CPV solar cells 226 and the PV solar cells 228 to obtain the total energy generated by the faces 210a, 210b, 210c and 210d. Then the controller estimates the energy that would be generated by the faces 210e, 210f, 210g and 210h of the solar panels 206a, 206b, 206c and 206d if those faces would be exposed using the above relationship and the measured energy generated by the PV solar cells 228. If the energy estimated for the faces 210e, 210f, 210g and 210h of the solar panels 206a, 206b, 206c and 206d is greater than the total energy measured for the faces 210a, 210b, 210c and 210d, the controller then exposes the faces 210e, 210f, 210g and 210h of the solar panels 206a, 206b, 206c and 206d. On the other end, if the energy estimated for the faces 210e, 210f, 210g and 210h of the solar panels 206a, 206b, 206c and 206d is less than the total energy measured for the faces 210a, 210b, 210c and 210d, the controller then continues exposing the faces 210a, 210b, 210c and 210d.

In still a further embodiment, the controller is adapted to identify the face of the solar panel assembly 202 to be exposed as a function of information about weather forecast. The controller is then adapted to receive information about weather forecast such as cloud forecast information from a server or a satellite for example. If the energy estimated for the faces 210e, 210f, 210g and 210h of the solar panels 206a, 206b, 206c and 206d.

In an embodiment in which the controller receives cloud forecast information, the cloud forecast information comprises the cloud coverage percentage and the altitude of the clouds. The controller is then adapted to estimate a first electrical power to be generated by the CPV solar cells 226 and the PV solar cells 228 under the received cloud forecast using the cloud coverage percentage and cloud altitude in order to estimate the electrical power to be generated if the faces 210a, 210b, 210c and 210d of the solar panels 206a, 206b, 206c and 206d are exposed. The controller also estimates a second electrical power to be generated by the PV solar cells 234 under the received cloud forecast using the cloud coverage percentage and cloud altitude in order to estimate the electrical power to be generated if the faces 210e, 210f, 210g and 210h of the solar panels 206a, 206b, 206c and 206d are exposed. The controller then exposes the face of the solar panel assembly 202 for which the greatest electrical power to be generated was estimated. For example, if the CPV solar cells 226 and the PV solar cells 228 are estimated to provide more electrical power than the PV solar cells 234, then the faces 210a, 210b, 210c and 210d of the solar panels 206a, 206b, 206c and 206d are exposed.

In one embodiment, the weather forecast information may be received periodically such as every two hours. In this case, the controller may consider that the received cloud forecast applies to a given period of time. In one embodiment, the received cloud forecast comprises a cloud coverage percentage as a function of time and a cloud altitude as a function of time, for a given period of time. In this case, the controller estimates the electrical power to be generated over the given period of time for both faces of the solar panel assembly 202 using the cloud coverage percentage as a function of time and a cloud altitude as a function of time. The controller then determines which face of the solar panel assembly 202 should be exposed using the estimated electrical power over the period of time for both faces of the solar panel assembly 202.

It should be understood that, when the controller determines that the faces 210a, 210b, 210c and 210d of the solar panels 206a, 206b, 206c and 206d should be exposed, the controller may be further adapted to orient the solar panel assembly 202 so as to track the sun using any method known in the art.

In one embodiment, the controller comprises at least one processing unit, a memory and communication means for communicating with the motorized frame and receiving weather forecast information. The communication means allow for wireless communication and/or wired communication. The processing unit is configured for performing the steps of the methods described above. For example, the processing unit is configured for controlling the motorized frame in order to position the solar panel assembly 102, 202 according to a given orientation to track the sun. The processing unit may also be configured for determining which face of the solar panel assembly 202 should be exposed using any method described above. The processing unit may further be configured for tracking the sun in order to maximize the electrical power generated by the CPV solar cells 134, 154, 226.

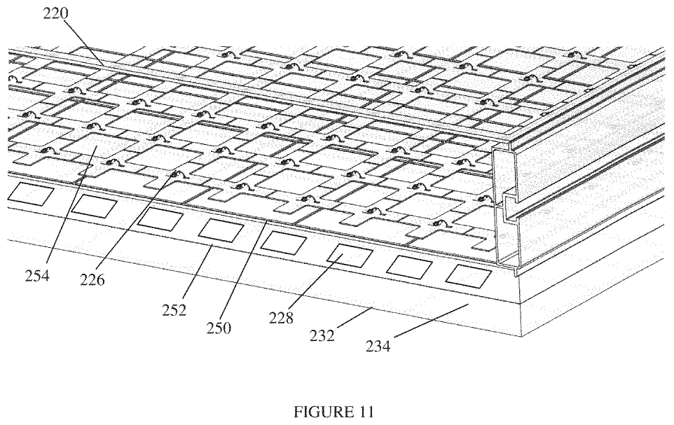

FIG. 10 is a block diagram illustrating an exemplary controller 300 for controlling the solar panel assembly 102, 202, in accordance with some embodiments. The processing module 300 typically includes one or more Computer Processing Units (CPUs) or Graphic Processing Units (GPUs) 302 for executing modules or programs and/or instructions stored in memory 304 and thereby performing processing operations, memory 304, and one or more communication buses 306 for interconnecting these components. The communication buses 306 optionally include circuitry (sometimes called a chipset) that interconnects and controls communications between system components. The memory 304 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 304 optionally includes one or more storage devices remotely located from the CPU(s) 302. The memory 304, or alternately the non-volatile memory device(s) within the memory 304, comprises a non-transitory computer readable storage medium. In some embodiments, the memory 304, or the computer readable storage medium of the memory 304 stores the following programs, modules, and data structures, or a subset thereof:
a frame control module 310 for controlling the rotation of the post 110 and/or 112;
a face exposition determining module 312 for determining which side of the solar panel assembly 202 should be exposed; and
a tracking module 314 for determining the orientation of the solar panel assembly 102, 202 in order to track the sun.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, the memory 304 may store a subset of the modules and data structures identified above. Furthermore, the memory 304 may store additional modules and data structures not described above.

Although FIG. 10 shows a processing module 300, FIG. 10 is intended more as functional description of the various features which may be present in a management module than as a structural schematic of the embodiments described herein. In practice, and as recognized by those of ordinary skill in the art, items shown separately could be combined and some items could be separated.

While the solar panel assembly 202 comprises PV solar cells 228 on the sides 210a, 210b, 210c and 210d of the solar panels 206a, 206b, 206c and 206d, it should be understood that the PV solar cells 228 may be omitted.

In another embodiment, the PV solar cells 228 may be mounted on a plate separate from the CPV solar cells 226, as illustrated in FIG. 11. In this embodiment, the solar module 208 comprises the concentrator plate 220, a first support plate 250 having the CPV solar cells 226 mounted thereto so as to face the concentrator plate 220, a second support plate 252 having the PV solar cells 228 mounted thereto so as to face the first support plate 250, and the support plate 232 having the PV solar cells 234 mounted thereto so that the PV solar cells 234 be oriented in a direction opposite to that of the CPV and PV solar cells 226 and 228. It should be understood that the first support plate 250 is transparent or semi-transparent so as to allow light to propagate therethrough up to the PV solar cells 228. In one embodiment, heat sinks 254 are mounted on the first support plate 250 in order to evacuate heat generated by the CPV solar cells 226. It should also be understood that the second support plate 252 and the third support plate 232 may be made of heat sink material. It should further be understood that the plate 232 or the plate 252 may be omitted so that the PV solar cells 228 and the PV solar cells 234 be mounted on opposite faces of a same plate.

While the above description refers to a concentrator plate 120, 220 having optical concentrators integrated therein, it should be understood that any adequate optical concentrator device adapted to focus light on CPV solar cells may be used. For example, the concentrator plate 120, 220 may be replaced by a film provided with array of lenses. In another example, each concentrator may be independent from the other concentrators, i.e., the concentrators are not integrated into a plate. For example, arms may be used for securing each concentrator to the support plate on which the CPV solar cells are mounted, a first end of the arms being secured to the concentrator and a second end of the arms being secured to the support plate so that each concentrator has a fixed position relative to its corresponding CPV solar cell while being aligned with its corresponding CPV solar cell.

It should be understood that the solar panel system 100, 200 may comprise further devices, modules and/or sub-systems For example, the solar panel system 100, 200 may comprise at least one solar inverters for converting the DC power generated by the solar cells to AC power. The solar panel system 100, 200 may comprise a string of inverters or a central inverter. The solar inverter may perform Maximum Power Point Tracking (MPPT) process, i.e., the solar inverter samples the output power (I-V curve) from the solar cells and applies the proper resistance (load) to the solar cells to obtain maximum power. The solar panel system 100, 200 may also comprise a switch gear connected to the grid for example.

The embodiments of the invention described above are intended to be exemplary only. The scope of the invention is therefore intended to be limited solely by the scope of the appended claims.

I/we claim:

1. A solar panel assembly comprising:
a base plate extending between a first face and a second face;
a plurality of concentrated photovoltaic (CPV) cells mounted on the first face of the base plate;
a plurality of optical concentrators each facing a respective one of the CPV cells; each one of the optical concentrators and the respective one of the CPV cells forming a CPV module for converting direct light into electricity; and
a plurality of photovoltaic (PV) cells for converting indirect light into the electricity.

2. The solar panel assembly of claim 1, wherein the PV cells are mounted on the first face of the base plate.

3. The solar panel assembly of claim 1, further comprising a secondary plate extending between a front face and a rear face.

4. The solar cell assembly of claim 3, wherein the PV cells being mounted on the front face of the secondary plate.

5. The solar panel assembly of claim 4, wherein the base plate is at least semi-transparent and the secondary plate is positioned beneath the base plate so that the PV cells face the second face of the base plate.

6. The solar panel assembly of claim 4, wherein the secondary plate is at least semi-transparent and the base plate is positioned beneath the secondary plate so that the CPV cells and the optical concentrators face the rear face of the secondary plate.

7. The solar panel assembly of claim 3, wherein the PV cells are mounted on the rear face of the secondary face, the front face of the secondary plate facing the second face of the base plate.

8. The solar panel assembly of any one of claims 1 to 7, wherein the base plate is made of heat sink material.

9. A solar panel system comprising:
a motorized rotatable frame;
the solar panel assembly of claim 9, the solar panel assembly being secured to the rotatable frame;
a controller for determining given ones of the CPV cells and the PV cells to be exposed and rotating the motorized rotatable frame in order to expose the determined cells.

10. The solar panel system of claim 9, wherein the controller is adapted to perform the determination based on information about weather forecast.

11. The solar panel system of claim 10, wherein the information about weather forecast comprises a cloud coverage percentage and an altitude of clouds.
